(19) United States
(12) Patent Application Publication
(10) Pub. No.: US 2008/0150317 A1
(43) Pub. Date: Jun. 26, 2008

(54) Motorcycle trailer

(76) Inventor: Richard Kilcrease, Wimberley, TX (US)

Correspondence Address: PATRICK STELLITANO, 2803 INRIDGE DR., AUSTIN, TX, 78745, US

(21) Appl. No.: 11/642,236

(22) Filed: Dec. 20, 2006

(51) Int. Cl. B60P 7/02

(52) U.S. Cl. 296/100.06

(57) ABSTRACT

A trailer for a motorcycle is provided. In one embodiment, the trailer comprises an aerodynamic body with an undercarriage and hitch arm with a mount for a spare tire under the body, and a mounting rack in front of the body for mounting a removable container. The body comprises an openable top hatch extending from one side of the body to the other to enable access to the storage interior of the body.

### FIELD

The present invention is in the field of trailers for motorcycles.

### BRIEF DESCRIPTION OF THE DRAWINGS

Advantages of the invention will become apparent upon reading the following detailed description and upon reference to the accompanying drawings in which, like references may indicate similar elements:

FIG. 1 depicts a perspective view of an embodiment of a motorcycle trailer.

FIG. 2 depicts a top view of an embodiment of a motorcycle trailer.

FIG. 3 depicts a side view of an embodiment of a motorcycle trailer.

FIG. 4 depicts a bottom view of an embodiment of a motorcycle trailer.

FIG. 5 depicts a rear view of an embodiment of a motorcycle trailer.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention as defined by the appended claims. The detailed description below is designed to render various embodiments obvious to a person of ordinary skill in the art.

A trailer for a motorcycle is provided. In one embodiment, the trailer comprises an aerodynamic body with an undercarriage and hitch arm with a mount for a spare tire under the body, and a mounting rack in front of the body for mounting a removable container. The body comprises an openable top hatch extending from one side of the body to the other to enable access to the storage interior of the body.

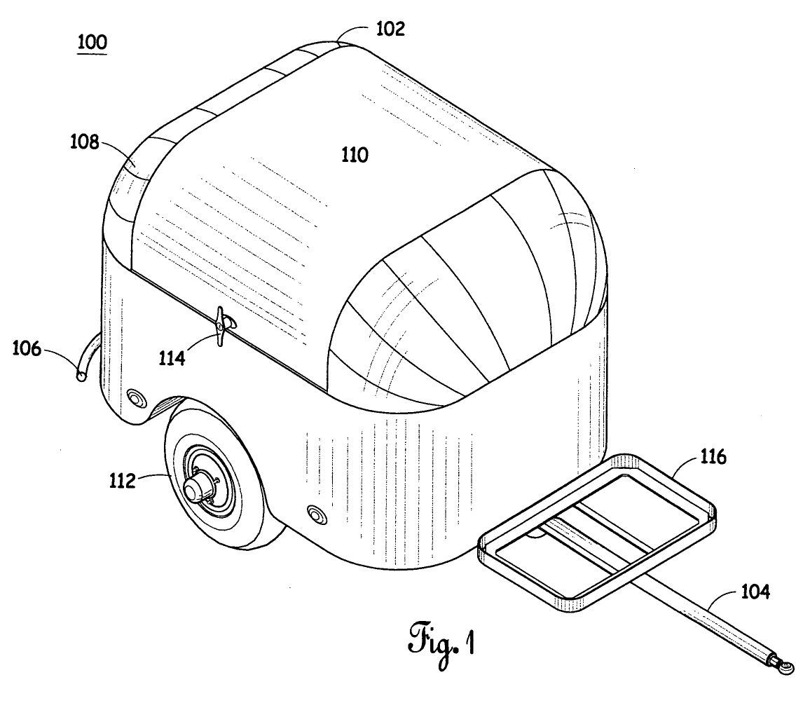

FIG. 1 is a perspective view of an embodiment 100 of a motorcycle trailer comprising a body 102 enveloping a storage space there within and an undercarriage with a hitch arm 104 and rear bumper 106. The body 102 comprises a top, four sides and a bottom. Each of the four corners of the top exhibit curvature and each of the four corners of the sides also exhibit curvature. The curvature provides aerodynamic stability and efficiency when the trailer is being towed at a slow, moderate, or high rate of speed.

In one embodiment, an interior wooden and/or metal frame provides support for a metal exterior. The wooden and/or metal frame may be constructed of a light weight material and the exterior metal body may be made of aluminum. For fuel efficiency, a light weight but sturdy construction is desirable. Thus, the exterior sides may be formed by wrapping a sheet of metal, such as aluminum, around a light-weight interior wooden and/or metal frame. In particular, substantially the entire periphery can be formed from a single sheet of metal, such as aluminum. In one embodiment, an arch is cut into each of a left side and a right side of the metal exterior to expose a wheel on each side so that each of the two tires of the trailer may be easily accessed for replacement.

At a top of a front end of body 102 of trailer 100 is a corner exhibiting curvature for aerodynamic stability. The curvature is formed by curved plates 108. In one embodiment, more than 3 curved plates form the curved front top corner for aerodynamic stability. The more than three curved plates may be partially but substantially overlapped to secure the interior in a water proof and wind proof manner. At a top of a rear end of body 102 of trailer 100 is another corner exhibiting curvature for aerodynamic stability. The curvature is, again, formed by curved plates 108. In one embodiment, more than 3 curved plates form the curved rear corner. The more than three curved plates may be partially but substantially overlapped to secure the interior in a water proof and wind proof manner.

The top of body 102 of trailer 100 comprises a top hatch 110. Top hatch 110 has two sides situated on the left and right sides of body 102 above wheels 112. A lockable latch mechanism 114 is provided on one side to latch and unlatch top hatch 110. On the opposite side are hinges (not shown). By unlatching latch mechanism 114 and lifting top hatch 110, hatch 110 pivots about the hinges so that top hatch 110 lifts upward to expose the interior of body 102 so that access is gained to items stored within body 102. The hinges of top hatch 110 may be spring loaded or otherwise biased so that when the top hatch is lifted, it remains in an up position until force is applied to bring it back down to the closed position. Thus, a traveler may accessibly store within the body 102, tents, blankets, camping supplies, compact stoves, clothing, food, water, fuel, oil, tools, etc. A substantial volume of weatherproof interior space is provided by body 102 for this purpose.

In one embodiment, a mounting rack 116 is provided. Mounting rack 116 is mounted on hitch arm 104 just in front of body 102. Mounting rack 116 may be used to mount a cooler or storage box. Thus, for example, an insulated cooler may be mounted on rack 116 and secured with straps, or other means. The cooler may store ice, cold drinks, and food. Access to the interior of the cooler is easily obtained without having to open top hatch 110 of body 102 of trailer 100.

Thus, one embodiment is a motorcycle trailer to be towed behind a motorcycle, comprising a body enveloping storage space there within. The body has a top, a bottom, and four vertical sides. Within the body, encompassed by outer surfaces formed of rigid but flexibile material such as aluminum is a light-weight frame to which the outer surfaces are formed there about. The body exhibits curvature, for aerodynamic efficiency and stability, around the corners of the top and around corners of the sides thereof. The curvature around the corners of a front end of the top is formed by more than three separate panels of curved material at a front end of the body and the curvature around a rear end of the top is formed by more than three separate panels of curved material at a rear end of the body. The front and rear panels substantially and partially overlap to weather proof the space within the body.

The top has an open-able top hatch to allow access to an interior of the body. The top hatch is curved around two sides with a lockable latch on one of the two sides to provide opening of the top hatch, and with hinges at an opposite one of the two sides. The hinges are biased to hold the top hatch in an open position. The body further exhibits on a left side and on a right side, an arch to expose a wheel on each of the left and right side.

An embodiment further comprises a steel undercarriage with a tubular hitch arm and a tubular bumper. The undercarriage supports the body at a bottom surface of the body. The undercarriage further comprises a mounting mechanism to securely mount a spare tire under the body. Mounted to the hitch arm of the undercarriage exterior to the body, is a mounting rack for mounting a removable container. The hitch arm has a swivel eye for receiving a securable pin connected to the motorcycle. The bumper is spaced apart from the rear of the body and conformal to the curvature of the corners of a rear end side of the body so that the bumper is curved at least partially around curved rear side corners of the body. The embodiment further comprises an independent action torsion suspension single axle system with two wheels mounted to the undercarriage. The embodiment also comprises side marker lights, license plate light and tail lights on the rear end of the body, the lights electrically connected to an electrical system of the motor cycle to indicate braking and left and right turn signals.

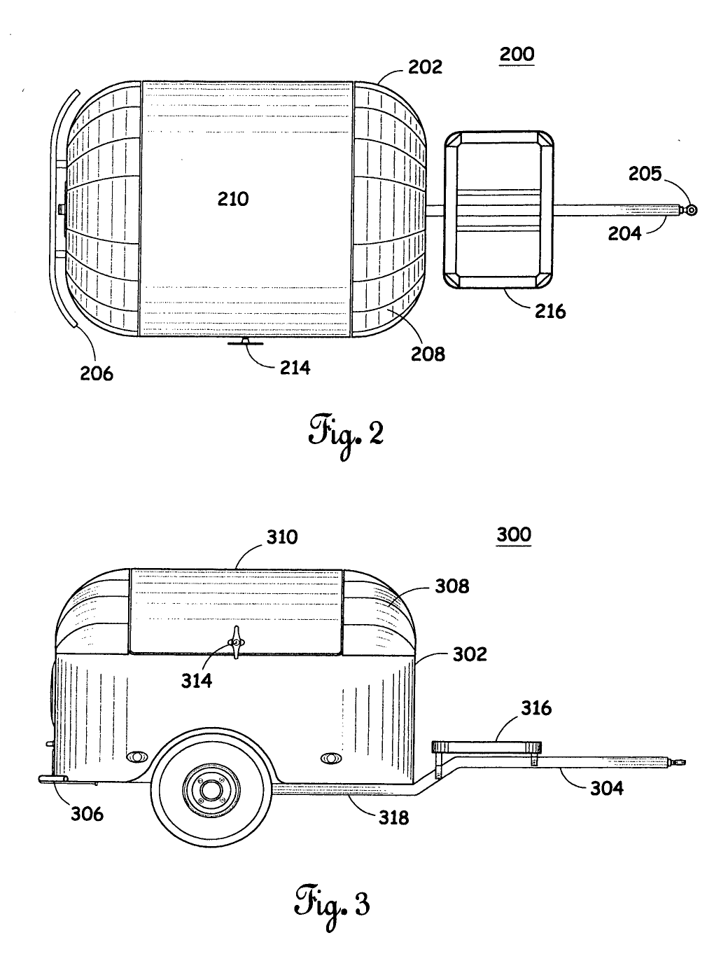

FIG. 2 is a top view of an embodiment of a motorcycle trailer 200. This view shows hitch arm 204 extending forward from a front of the body 202 of the trailer 200. At an end of hitch arm 204 is a swivel eye 205 to receive a securable pin for easy connection to a towing motorcycle. Mounted on hitch arm 204 is a mounting rack 216 for mounting a cooler or storage box external to body 202. The top view shows that all corners of the top section of body 202 are curved for aerodynamic efficiency. Corners at the front and rear end of body 202 are formed by curved panels 208. The top view also shows that a bumper 206, extending from an undercarriage and offset from the trailer body, is curved to conform to the curved corners of the sides. Top hatch 210 extends from one side of body 202 to the other side with a lockable latch mechanism 214 on one side. Thus, top hatch 210 is lifted to give access to the interior of body 202.

FIG. 3 is a side view of an embodiment of a motorcycle trailer 300. Trailer 300 comprises a body 302 with curved corners for aerodynamic efficiency. At front and rear corners of the top of body 302 are curved panels 308 for forming curved corners. Curved panels 308 are partially overlapped to provide weather proofing of the interior of body 302. Curved panels 308 may be made of a light weight yet strong material such as aluminum. In one embodiment, a light weight frame formed of wood and/or metal, for example, is formed and enclosed within the interior of body 302 to provide a frame to which the curved panels 308 are attached or adhered. In another embodiment, the curved corners at the front and rear of the top are molded from 18 individual pieces into a single piece of material.

As shown in FIGS. 2 and 3, a top hatch (210, 310), extends fully across the top and is curved to extend partially on the left and right sides so that when the top hatch is opened, a large opening is provided to gain access to the interior of the body of the trailer. Latching mechanism 314 is preferably lockable to lock the top hatch in a closed position. Latch 314 may be locked and unlocked with a key. FIGS. 2 and 3 also show that a rear bumper 206, 306 extends at least partially around the curved corners of body 310. An undercarriage 318, of which a hitch arm 304 is integrally formed, extends below a bottom surface of body 302. Mounted on hitch arm 304, which is an extension of undercarriage 318, is a mounting rack 316 for mounting a cooler or storage box external to the body 302.

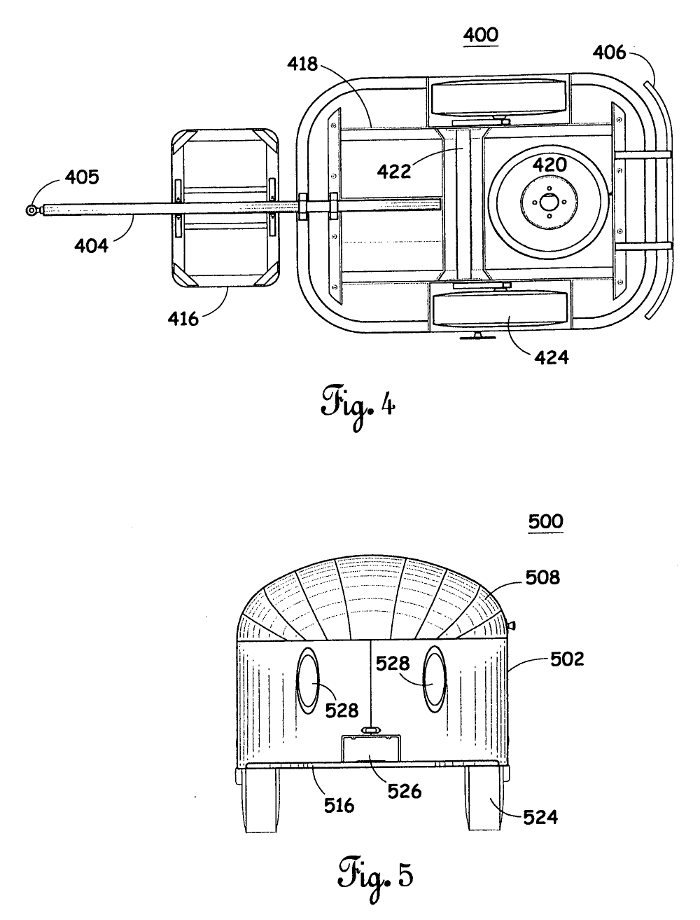

FIG. 4 is a bottom view of an embodiment of a motorcycle trailer 400. FIG. 4 shows an undercarriage 418 mounted to the bottom surface of a trailer body to support the trailer body from the bottom. Undercarriage 418 comprises a hitch arm 404. In one embodiment, the hitch arm 404 comprises a tubular structure integrally formed with the undercarriage. In another embodiment, hitch arm 404 is removably connectable to undercarriage 418. At an end of hitch arm 404 is a swivel eye 405 for receiving a securable pin of a motorcycle to easily couple the trailer to the motorcycle. Mounted to hitch arm 404 is a mounting rack 416 to mount a removable cooler or storage box for rain gear, tools, etc, for example. This enables quick access without having to open the top hatch of the trailer and search for frequently utilized items there within.

At a rear end of undercarriage 418 is a rear bumper 406. In one embodiment, bumper 406 comprises a tubular structure integrally formed with undercarriage 418. In another, embodiment, bumper 406 is removably connectable to undercarriage 418. FIG. 4 also shows a spare tire 420 removably mounted to undercarriage 418. Thus, the space under the body of trailer 400 is efficiently utilized so that space inside the body does not need to be occupied by the spare tire. Mounted to undercarriage 418 is a single axle 422 and at each end of the axle is a wheel 424. In one embodiment, the axle and wheel assembly provides for independent action torsion suspension in a single axle to absorb shock when a wheel hits an irregularity in the road.

FIG. 5 is a rear end view of an embodiment of a motorcycle trailer 500. FIG. 5 shows the curvature of the top formed by more than three panels 508 that may be substantially partially overlapped to provide weatherproofing of the interior of trailer body 502. FIG. 5 also shows wheels 524 and bumper 515. Also included is a fixture for mounting a vehicle license plate which is required by law in practically all jurisdictions. Further provided are side marker lights, license plate light and rear tail lights 528. The tail lights are connected to an electrical system of the motorcycle to indicate braking and left and right turn signals.

Thus, one embodiment is a motorcycle trailer, comprising a body enclosing storage space there within. The body has an openable top hatch to expose the interior space of the body. The hatch has biased hinges to hold the top hatch in an open position when opened. An undercarriage is mounted to a bottom of the body to provide support there for. The undercarriage comprises a mounting mechanism to mount a spare tire underneath the body. An axle and two wheels are mounted to the undercarriage with torsion suspension. A hitch arm is connected to the undercarriage and extends forward from the body to couple with the motorcycle. A mounting rack is mounted to the hitch arm exterior to the body to hold a removable storage container.

In one embodiment, the body has four vertical sides with rounded corners and a top with rounded corners on the front and rear ends and the sides there of. The rounded corners on the front and rear ends of the top comprise more than three shaped panels on each end. The panels are substantially and partially overlapped to provide weatherproofing of the interior of the body. In some embodiments, the four vertical sides comprise a sheet of metal, such as aluminum, wrapped around and connected to an interior light-weight wooden and/or metal frame with arches cut into the sheet to expose the two wheels. In one embodiment the front and rear corners of a top of the body are molded from 18 individual panels into a single piece of material.

The openable top hatch extends across the top to both a left and right side of the body with curvature on the sides there of. The openable top hatch has a lockable latch mechanism to lock the top hatch in a closed position and to open the top hatch. In some embodiments, the hitch arm comprises a swivel eye to receive a securable pin connected to the motorcycle for coupling there to. Some embodiments also have a tubular bumper connected to the undercarriage and rounded at the ends to at least partially encompass curved rear corners of sides of the body. Also, embodiments may further comprise side marker lights, license plate light and rear tail lights connected to an electrical system of the motorcycle to provide braking lights and left and right turn signals.

Although the present invention and some of its advantages have been described in detail for some embodiments, it should be understood that various changes, substitutions and alterations can be made herein without departing from the spirit and scope of the invention as defined by the appended claims. Although an embodiment of the invention may achieve multiple objectives, not every embodiment falling within the scope of the attached claims will achieve every objective. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A motorcycle trailer to be towed behind a motorcycle, comprising:
a body enveloping storage space there within, the body having a top, a bottom, and four vertical sides, and there within, encompassed by outer surfaces formed of rigid material, a light-weight frame to which the outer surfaces are formed there about; the body exhibiting curvature, for aerodynamic efficiency and stability, around the corners of the top and around corners of the sides thereof; the curvature around the corners of a front end of the top formed by more than three separate panels of curved material at a front end of the body and the curvature around a rear end of the top formed by more than three separate panels of curved material at a rear end of the body, the front and rear panels substantially and partially overlapped to weather proof the space within the body; the top having an open-able top hatch to allow access to an interior of the body, the top hatch curved around two sides with a lockable latch on one of the two sides to provide lockable opening of the top hatch, and hinges at an opposite one of the two sides, the hinges biased to hold the top hatch in an open position; the body further exhibiting on a left side and on a right side, an arch to expose a wheel on each of the left and right side;
a steel undercarriage with a tubular hitch arm and a tubular bumper, the undercarriage supporting the body at a bottom surface of the body; the undercarriage further comprising a mounting mechanism to securely mount a spare tire under the body; mounted to the hitch arm of the undercarriage exterior to the body, a mounting rack for mounting a removable container; the hitch arm with a swivel eye for receiving a securable pin connected to the motorcycle; the bumper spaced apart from the rear of the body and conformal to the curvature of the corners of a rear end side of the body so that the bumper is curved at least partially around curved rear side corners of the body;
an independent action torsion suspension single axle system with two wheels mounted to the undercarriage; and
side marker lights, license plate light and tail lights on the rear end of the body, the tail lights electrically connected to an electrical system of the motor cycle to indicate braking and left and right turn signals

2. A motorcycle trailer, comprising:
a body enclosing storage space there within, with an openable top hatch to expose the interior space of the body, the hatch with biased hinges to hold the top hatch in an open position when opened;
an undercarriage mounted to a bottom of the body to provide support there for, the undercarriage comprising a mounting mechanism to mount a spare tire underneath the body;
an axle and two wheels mounted to the undercarriage with independent torsion suspension;
a hitch arm connected to the undercarriage and extending forward from the body to couple with a motorcycle; and
a mounting rack mounted to the hitch arm exterior to the body to hold a removable storage container.

3. The trailer of claim 2, wherein the body has four vertical sides with rounded corners and a top with rounded corners on the front and rear ends and the sides there of, the rounded corners on the front and rear ends of the top comprising more than three shaped panels on each end, the panels substantially and partially overlapped to provide weatherproofing of the interior of the body.

4. The trailer of claim 3, wherein the four vertical sides comprise a sheet of metal, such as aluminum, wrapped around and connected to an interior light-weight wooden and/or metal frame with arches cut into the sheet to expose the two wheels.

5. The trailer of claim 2, wherein the body comprises four vertical sides comprising a single sheet of metal wrapped around an interior frame.

6. The trailer of claim 2, wherein front and rear corners of a top of the body are molded from 18 separate panels into a single piece of material.

7. The trailer of claim 2, wherein the openable top hatch extends across the top to both a left and right side of the body with curvature on the sides there of.

8. The trailer of claim 6, wherein the openable top hatch has a lockable latch mechanism to lock the top hatch in a closed position and to open the top hatch.

9. The trailer of claim 2, wherein the hitch arm comprises a swivel eye to receive a securable pin connected to the motorcycle for coupling there to.

10. The trailer of claim 2, further comprising a tubular bumper connected to the undercarriage and rounded at the ends to at least partially encompass curved rear corners of sides of the body.

11. The trailer of claim 2, further comprising side marker lights, license plate light and rear tail lights connected to an electrical system of the motorcycle to provide braking lights and left and right turn signals.
